(19) United States
(12) Patent Application Publication
(10) Pub. No.: US 2010/0015304 A1
(43) Pub. Date: Jan. 21, 2010

(54) APPARATUS AND METHOD FOR STERILIZING FOOD PRODUCTS

(75) Inventor: Luc Sauvageau, Repentigny (CA)

Correspondence Address: FASKEN MARTINEAU DUMOULIN, LLP, STOCK EXCHANGE TOWER, SUITE 3700, P.O. BOX 242, 800 PLACE VICTORIA, MONTREAL, QC, H4Z 1E9, CA

(73) Assignee: TOMAPURE INC., Laval (CA)

(21) Appl. No.: 12/505,136

(22) Filed: Jul. 17, 2009

Related U.S. Application Data
(60) Provisional application No. 61/081,871, filed on Jul. 18, 2008.

(51) Int. Cl. A23L 3/28

(52) U.S. Cl. 426/248; 99/451

(57) ABSTRACT

The present invention generally pertains to an apparatus and a method for cleaning, drying and sterilizing a food product, and more specifically a perishable food product such as tomatoes. More specifically, the present invention relates to an apparatus comprising a roller conveyor for sequentially conveying the food products through a washing station, a drying station and a sterilization station The sterilization station makes use of UV light for destroying micro-organisms that may be found on the surface of the food product, the food products being caused to rotate while traveling through the sterilization station.

### CROSS REFERENCE TO RELATED APPLICATIONS

This application claims priority of U.S. provisional application No. 61/081,871, entitled “APPARATUS AND METHOD FOR STERILIZING FOOD PRODUCTS”, that was filed on Jul. 18, 2008, the specification of which is hereby incorporated by reference.

### FIELD OF THE INVENTION

The present invention generally relates to an apparatus and a method for sterilizing food products. More specifically, the present invention relates to an apparatus comprising a roller conveyor for conveying the food products sequentially through a washing station, a drying station and a sterilization station. The sterilization station makes use of a radiation source for destroying micro-organisms that may be found on the surface of the food product, the food products being caused to rotate while traveling through the sterilization station.

### BACKGROUND OF THE INVENTION

Production of ready-to-eat food products requires multiple preparation steps. In the case of perishable food products, such as fruits and vegetables, the preparation steps typically comprise washing the food products and sterilizing the same before packaging.

In most of the cases, sterilization of the food products is conducted using a chemical agent such as chlorinated water or peroxide derivatives. Chemical sterilization tends to leave traces of chemical agents on the surface of the food products, which may not be desirable when the food product is packaged for immediate consumption.

Sterilization methods which do not require the use of chemical agents include heat sterilization (e.g. pasteurization) and ultraviolet (UV) light sterilization. Heat sterilization tends not to be suitable for use with raw fruits and vegetables since such sterilization method may result in cooking the food products. Similarly, sterilization of food products using UV-light tend to be of limited use with fruits and vegetables. Indeed, the penetration of UV light through surfaces is known to be limited, which makes challenging the sterilization of rounded or irregular surfaces such as those of fruits and vegetables. Thus, UV sterilization tends to be used only for those objects having generally planar surfaces.

Therefore, it would be desirable to be provided with an apparatus and a method for sterilizing food products that will overcome at least one of the above-mentioned drawbacks.

### BRIEF SUMMARY

According to one embodiment, there is provided an apparatus for sterilizing a product using radiation. According to this embodiment, the apparatus comprises:

a conveyor assembly having a back end and a front end, the conveyor assembly being adapted for conveying the product between the back end and the front end;

a radiation source mounted on the conveyor in an intermediate location between the back end and the front end, the radiation source being adapted for allowing the passage of the food product from the back end of the conveyor assembly and the front end and directing a radiation beam toward the product; and

means for causing rotation of the product as it is conveyed between the back end and the front end of the conveyor assembly, the rotation enabling the food product to be uniformly reached by the radiation beam.

According to another embodiment, the radiation comprises an Ultraviolet (UV) light and the radiation source comprises a UV light-emitting source.

According to a further embodiment, the apparatus further comprises a screening station for screening the product before subjecting the same to the radiation beam, the screening station being located between the back end of the conveyor assembly and the radiation source.

According to yet a further embodiment, the apparatus further comprises a transversal conveyor for facilitating discard of a reject product, the transversal conveyor being mounted to the conveyor assembly between the back end of the conveyor assembly and the radiation source.

According to another embodiment, the apparatus further comprises a washing station for washing the product before subjecting the same to the radiation beam, the washing station being mounted to the conveyor assembly between the back end and the radiation source.

According to yet another embodiment, the apparatus further comprises a drying station for drying the product before subjecting the same to the radiation beam, the drying station being mounted to the conveyor assembly between the washing station and the radiation source.

According to a further embodiment, the apparatus further comprises a discharge station mounted at the back end of the conveyor assembly for feeding the product on the conveyor assembly.

According to yet a further embodiment, the apparatus further comprises a packaging station mounted at the front end of the conveyor assembly. According to one embodiment, the packaging station may comprise at least one chute.

According to another embodiment, the apparatus further comprises a shield mounted over the radiation source for limiting unwanted reflection of the radiation beam.

According to yet another embodiment, the means for causing rotation is operatively coupled to the conveyor assembly. According to a further embodiment, the means for causing rotation is a roller conveyor.

According to one embodiment, the product comprises a food product, where the food product may comprise a perishable food product. The perishable food product may be selected from the group consisting of a fruit and a vegetable, and may comprise a tomato.

According to another embodiment, there is provided an apparatus for sterilizing a food product using Ultraviolet (UV) light, the apparatus comprising:

a roller conveyor assembly having a back end and a front end, the roller conveyor assembly being adapted for conveying the product between the back end and the front end;

a UV light-emitting source mounted on the conveyor in an intermediate location between the back end and the front end, the UV light-emitting source being adapted for allowing the passage of the food product from the back end of the conveyor assembly and the front end and directing a UV light beam toward the product;

a screening station for screening the food product before subjecting the same to the UV light beam, the screening station being located between the back end of the conveyor assembly and the UV light source;

a washing station for washing the product before subjecting the same to the radiation beam, the washing station being mounted to the conveyor assembly between the screening station and the UV light source; and

a drying station for drying the product before subjecting the same to the UV light beam, the drying station being mounted to the conveyor assembly between the washing station and the UV light source.

wherein the roller conveyor assembly causes the food product to rotate while being conveyed between the back ends and the front end of the roller conveyor assembly, the rotation enabling the food product to be uniformly reached by the UV light beam.

According to another embodiment, the apparatus further comprises a transversal conveyor for facilitating discard of a reject product, the transversal conveyor being mounted to the conveyor assembly between the back end of the conveyor assembly and the radiation source.

According to yet another embodiment, the apparatus further comprises a packaging station mounted at the front end of the conveyor assembly.

According to a further embodiment, the packaging station comprises at least one chute.

According to yet a further embodiment, the apparatus further comprises a shield mounted over the UV light source for confining the UV light beam.

According to another embodiment, there is provided a method for sterilizing a food product using Ultra Violet (UV) light. According to one embodiment, the method comprises:

providing a UV light source for emitting a UV light beam;

exposing the food product to the UV light beam while rotating the food product for enabling the same to be uniformly reached by the UV light beam.

According to one embodiment, the method further comprises screening the food product prior to exposing the food product to the UV light beam.

According to another embodiment, the method further comprises washing the food product prior to exposing the food product to the UV light beam.

According to yet another embodiment, the method further comprises drying the food product after washing and prior to exposing the food product to the UV light beam.

According to another embodiment, there is provided a method for packaging ready-to-eat food products, the method comprising:

providing unprocessed food products;

screening the unprocessed food products to separate quality food products and rejected food products;

washing the quality food products to obtained washed food products;

drying the washed food products to obtain dry food products;

submitting the dry food products to a Ultraviolet (UV) light beam while rotating the same such that the food products are uniformly reached by the UV light beam to obtain the ready-to-eat food products;

packaging the ready-to-eat food products in a container.

The methods and apparatuses of these embodiments allows sterilization of products having rounded or irregular surfaces such as fruit and vegetable without requiring the use of chemical agents and without heat that may result in cooking the said products. These and other objects, advantages and features of the present invention will become more apparent to those skilled in the art upon reading the details of the invention more fully set forth below.

### BRIEF DESCRIPTION OF THE DRAWINGS

Having thus generally described the nature of the invention, reference will now be made to the accompanying drawings, showing by way of illustration an illustrative embodiment thereof, and in which:

FIG. 1 is a front perspective view of an apparatus for sterilizing food products in accordance with one embodiment of the present invention;

FIG. 2 is a top plan view of the apparatus shown in FIG. 1;

FIG. 3 is a left elevation view of the apparatus shown in FIG. 1;

FIG. 4 is a cross-section view of the apparatus shown in FIG. 2, taken along line IV-IV;

FIG. 5 is a front elevation view of the apparatus shown in FIG. 1;

FIG. 6A is a front left perspective view of a fist chute of the apparatus shown in FIG. 1; and

FIG. 6B is a front left perspective view of a second chute of the apparatus shown in FIG. 1;

FIG. 7 is a front perspective view of an apparatus for sterilizing food products in accordance with another embodiment of the present invention, with the radiation shield removed; and

FIG. 8 is a front perspective view of the apparatus for sterilizing food show in FIG. 7, with the radiation shield in position and a portion of the top wall thereof removed.

### DESCRIPTION OF THE ILLUSTRATIVE EMBODIMENTS

The description which follows, and the embodiments described therein are provided by way of illustration of an example, or examples of particular embodiments of principles and aspects of the present invention. These examples are provided for the purpose of explanation and not of limitation, of those principles of the invention. In the description that follows, like parts are marked throughout the specification and the drawings with the same respective reference numerals.

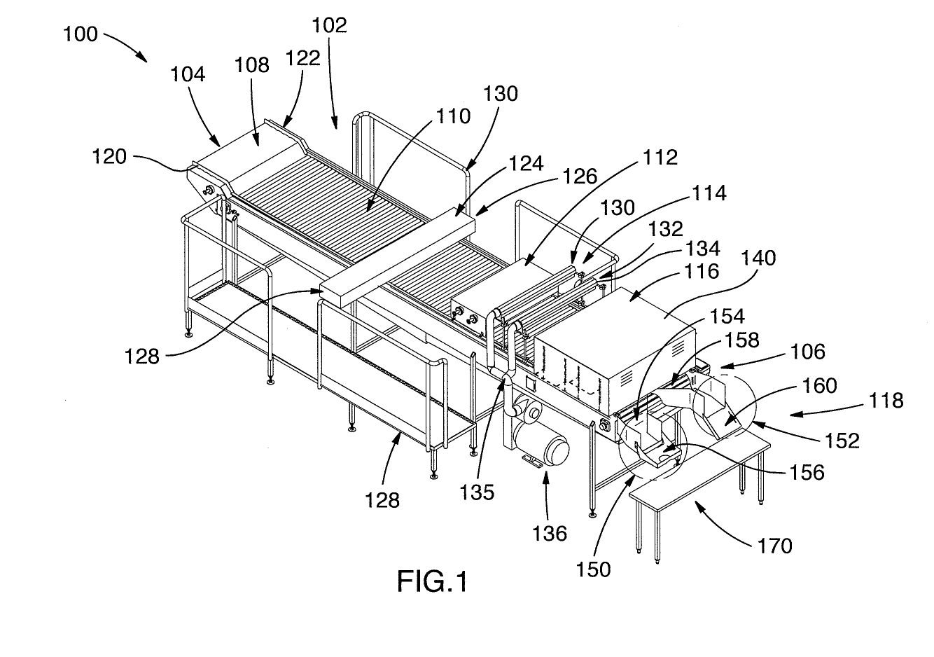

With reference to FIG. 1, an apparatus for sterilizing food products according to one embodiment is shown using the reference numeral 100. The apparatus 100 can be used for sterilizing a wide variety of food products, and preferably perishable food products such as fruits and vegetables having a generally rounded shape. More preferably, the apparatus 100 is used for sterilizing tomatoes, and even more preferably grape tomatoes.

In one embodiment, the apparatus 100 is adapted for sterilizing food products without requiring the use of chemical agents. As it will become apparent, the apparatus benefits from a radiation source to provide a clean, ready-to-eat food product exempt from those chemical agents traditionally used for sterilization purposes. In addition of being capable of sterilizing food products, the function of the apparatus 100 may also extend to washing and drying the food products before subjecting the same to a sterilization step. Indeed, the preparation of ready-to-eat food products may require washing to remove leaves, soil, herbicide, pesticides and other contaminants from the surface of the food products prior to subjecting the same to sterilization.

While in a preferred embodiment the apparatus is used for sterilizing food product, a person skilled in the art will appreciate that any object having a rounded or irregular surface and requiring sterilization may be subjected to sterilization with the apparatus. For instance, one may find beneficial to sterilize objects such as balls that are further sold to children, daycares or playgrounds, or any other object that may need to be germ free and for which the use of heat or chemical agents may be inconvenient.

In one embodiment, the apparatus 100 comprises a conveyor assembly 102 mounted on a generally flat surface such as a floor, where the conveyor assembly 102 comprises a back end 104 and an opposed front end 106. The apparatus 100 further comprises a discharge station 108 mounted at a back end 104 of the conveyor assembly 102 for discharging the food product to be processed on the conveyor assembly 102. Moving from the back end 104 of the conveyor assembly 102 towards the front end 106 thereof, the apparatus 100 is sequentially provided with a screening station 110, a washing station 112, a drying station 114 and a sterilization station 116. Provided at the front end 106 of the conveyor assembly 102 is a packaging station 118 for packaging the clean, sterile and ready-to-eat food products.

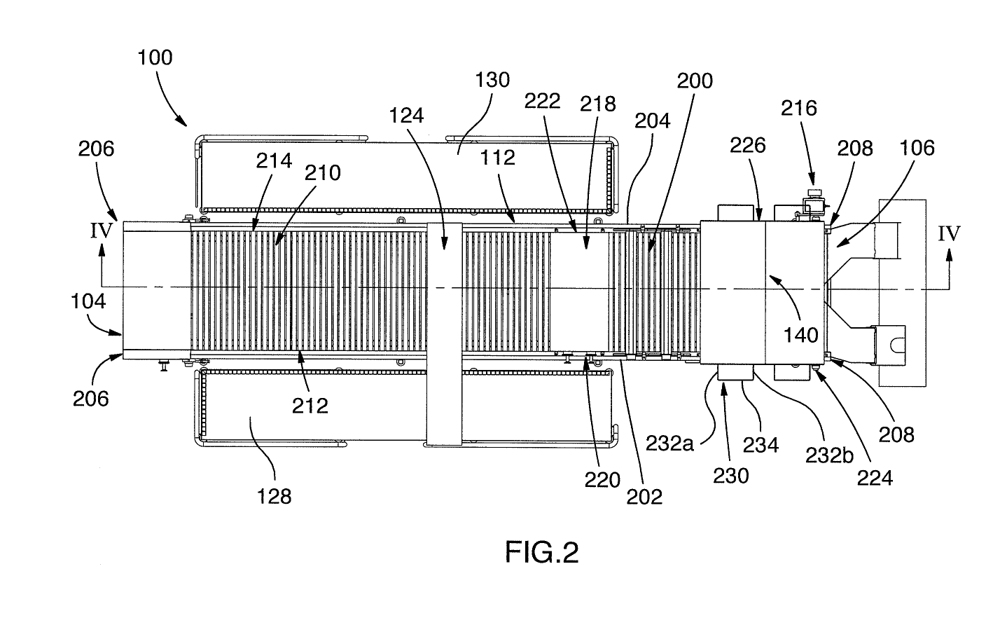

In one embodiment, the conveyor assembly 102 comprises a roller conveyor 200 supported on the floor by a plurality of legs 300 (best shown in FIGS. 2 to 4). The roller conveyor 200 comprises a pair of spaced-apart, parallel frame members 202, 204, each frame member 202, 204 having a back end 206 and a front end 208. The back and front ends 206, 208 of the frame members 202, 204 correspond to the back and front ends 104, 106 of the conveyor assembly 102, respectively. The frame members 202, 204 are connected to one another by a plurality of cross-members 302. The roller conveyor 200 further comprises a pair of lower slides 400 and a pair of upper slides 402 on which is traveling an endless track of rollers 404, as best described below.

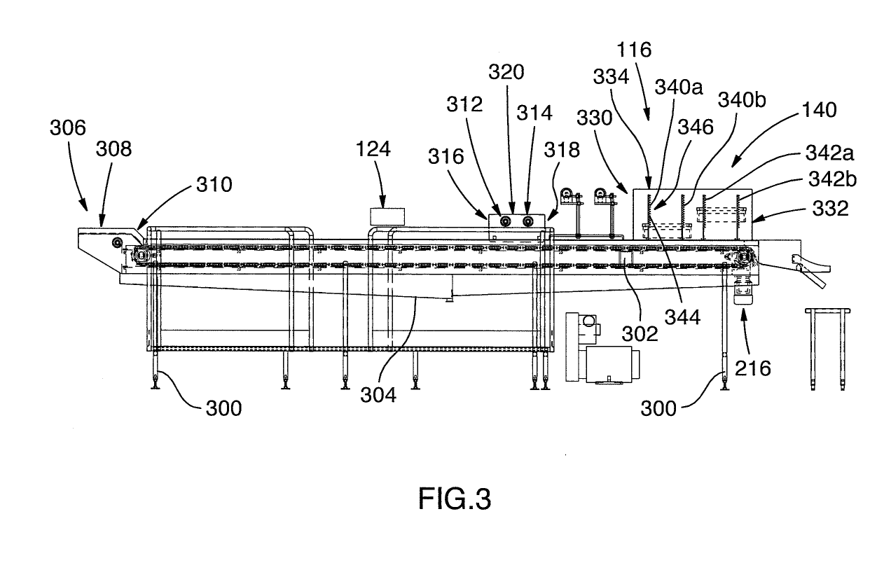

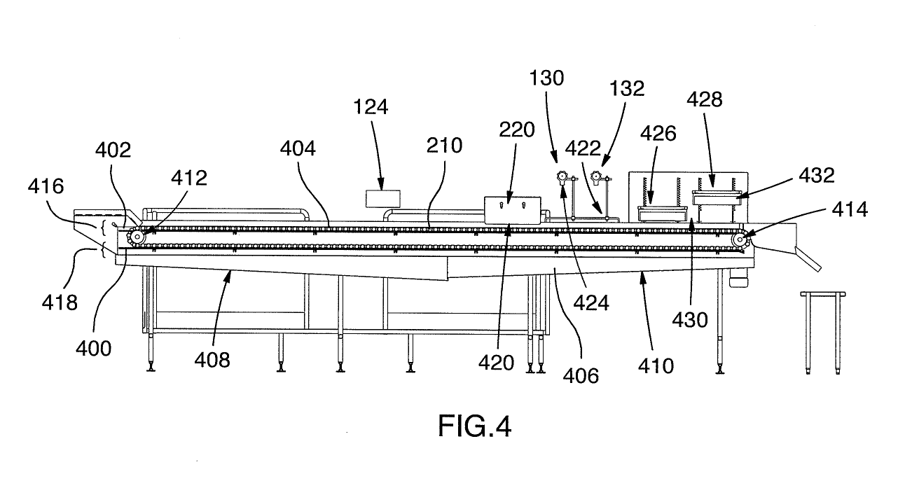

Provided under the frame members 202, 204 of the roller conveyor 200 is a collection pan 304 (best shown in FIGS. 3 and 4). The collection pan 304 comprises a pair of spaced-apart, triangle-shaped side walls 406 and first and second bottom walls 408, 410, respectively. Each triangle-shaped side wall 406 extends downwardly from a corresponding frame member 202, 204, the tip thereof being located generally halfway between the back and front ends 206, 208 of the frame members 202, 204 and projecting toward the floor. The first bottom wall 408 extends between the triangle-shaped side walls 406, from the back end 206 of the frame members 202, 204 to the tip of the side walls 406. The second bottom wall 410 is sealingly connected to the first bottom wall 408 and extends between the tip of the side walls 406 and the front end 208 of the frame members 202, 204. As such, the configuration of the collection pan 304 is adapted for collecting the debris, contaminant and water used for washing the food product and for converging the same toward the junction of the bottom walls 408, 410.

For draining the water and the debris contained by the collection pan 304, a drain pipe (not shown) is connected by a first end to the collection pan 304 and by a second end to a sewer. A person skilled in the art will appreciate that filtering means or crushing means (not shown) could be provided to facilitate the evacuation of the liquids and/or solid particles from the pan 304. Further, to reduce the water consumption used for washing the food products, the drain pipe may be connected to a water recycling (not shown) system rather than being connected to a sewer. Such a water recycling system may include filters for removing the contaminants from the washing water and returning the water exempt from contaminants toward the washing station 112.

A back pulley 412 and a front pulley 414 extend between the frame members 202, 204 at the back end 206 and the front end 208 respectively. The back and front pulleys 412, 414 are capable of rotation and are adapted for mounting the endless track of rollers 404 to the frame members 202, 204 and to drive movement thereof. The endless track of rollers 404 comprises a pair of left and right endless belts (not shown) mounted in a side-by-side relationship on the back and front pulleys 412, 414 and extending between the back end 104 of the conveyor assembly 102 and the front end 106 thereof, each endless belt being proximal to one of the frame members 202, 204. The endless track of rollers 404 further comprises a plurality of rollers 210 mounted to the endless belts (not shown). More specifically, each roller 210 comprises a left end 212 and a right end 214. The left and right ends 212, 214 of each roller 210 are rotatably mounted to the left and right belts (not shown), respectively, such that it can freely rotate about a horizontal axis while traveling from the back end 104 of the conveyor assembly 102 to the front end 106 thereof, as it will become apparent below. In one embodiment, the rollers 210 are distributed evenly on the entire length of the left and right belts (not shown), perpendicular to the frame members 202, 204. According to this embodiment, the number of rollers 210 provided on the endless track 404 is adapted such that the distance between each roller 210 is optimized for causing change of orientation of the food product conveyed while avoiding the same to fall between the adjacent rollers 210, as it will become apparent below. For instance, in the case where tomatoes are processed, the distance between each roller (from rotation axis to rotation axis) may range from about 0.3 centimeters (e.g. for cherry and/or grape tomatoes) to about 3 centimeters (e.g. for larger size tomatoes).

For urging the endless track of rollers 404 to travel between the back end 104 of the conveyor assembly 102 and the front end 106 thereof, the conveyor assembly 102 is provided with a drive assembly operatively coupled to at least one of the front and back pulley 412, 414. According to one embodiment, the drive assembly 216 comprises an electric motor 500 coupled to the front drive pulley 414 by a gearbox transmission 502. A person skilled in the art will appreciate that any other drive assembly known in the art and suitable for use with a conveyor assembly could substitute the electric motor and the gearbox transmission.

As the drive assembly 216 is actuated, it causes the front pulley 414 to urge movement of the left and right belts (not shown) and of the plurality of rollers 210 carried thereby. More specifically, the upper portion 416 of the endless track of roller 404 (i.e. the portion on which are receive the food products) is urged to move front the back end 104 of the conveyor assembly 102 towards the front end 106 thereof while the lower portion 418 (i.e. the portion exempt from food product, located below the upper portion) is urged to return toward the back end 104 of the conveyor assembly 102. As the endless track of roller 404 is urged to move, the rollers 210 of the upper portion 416 contact the upper slides 402 of the conveyor assembly 102. Upon contact with those slides 402, the rollers 210 of the upper portion 416 are forced to rotate, countersense to the rotation direction of the back and front pulleys 412, 414 (i.e. where the back and front pulleys 412, 414 rotate clockwise, the rollers 210 of the upper portion rotate 416 counterclockwise). As such, the rotation of the rollers 210 causes the food products conveyed to change of orientation on them while being conveyed from the back end 104 of the conveyor assembly 102 toward the front end 106 thereof. As it will be best described below, such change of orientation of the food products on themselves provides with uniform washing, drying and sterilization as the products move sequentially through the screening, washing, drying and sterilization stations 110, 112, 114 and 116, respectively.

While in this embodiment a roller conveyor is used, a person skilled in the art will appreciate that numerous conveyor configurations enabling a change of orientation of the product conveyed would be possible. For instance, the conveyor assembly 102 could be replaced by a vibrating belt conveyor. Alternatively, the conveyor assembly 102 could be substituted by a conveyor assembly provided with air jets strategically positioned for urging the change of orientation of the food product as it is conveyed through the different stations.

The discharge station 108 is mounted at the back end 104 of the conveyor assembly 102 and generally comprises a discharge plate 306 extending between the frame members 202, 204 and adapted for receiving thereon the food products to be processed and directing the same toward the endless track of rollers 404, at the back end thereof. More specifically, the discharge plate 306 comprises a generally horizontal portion 308 and an angled portion 310 extending downwardly from the horizontal portion 308, at the front end thereof.

In one embodiment, the horizontal and angled portions 308, 310 of the discharge plate 306 define an integral structure. For preventing the food product discharged on the discharge plate 306 to fall on each side of the frame members 202, 204, the discharge station 108 is further provided with a pair of side guards 120, 122 extending upwardly from the discharge plate 306, on each side thereof.

Downstream from the discharge station 102 is the washing station 112. The washing station 112, which will be described in greater detail below, is mounted to the conveyor assembly 102 at an intermediate position between the back and front ends 104, 106, the distance separating the discharge station 108 and the washing station 112 representing approximately ⅔ the distance between such back and front ends 104, 106. Thus, a major portion of the endless roller track conveyor 404 remains uncovered proximal to the back end 104 of the conveyor assembly 102. As it will become apparent below, the uncovered portion of the conveyor assembly 102 enables workers to perform a screening of the food products processed before they reach the washing, drying and sterilization stations 112, 114 and 116; this portion of the conveyor assembly 102 is thus designated as the screening station 110 so as to separate the rejected food products (or, in other words, the “rejects”) from the quality food products. As the food products, for instance grape tomatoes, are conveyed through the screening station 110, the workers may visually screen and manually discard the damaged tomatoes, those who would require further maturation (i.e. green tomatoes) and all other tomatoes that do not meet the quality standards for further being packaged and distributed.

In order to facilitate the manual discard of the rejected food products, the apparatus 100 may be provided with a transversal conveyor 124. The transversal conveyor is preferably mounted over to the frame members 202, 204 and extends perpendicular to the conveyor assembly 102. The transversal conveyor 124 may be a typical belt conveyor and comprises a first end 126, adjacent to the right frame member 204, and a left end 128, extending away from the left frame member 202, toward a discharge bin (not shown) where the rejects can be collected. As best shown in FIG. 4, the transversal conveyor 124 is positioned on the frame members 202, 204 such that a travel space is defined between the transversal conveyor 124 and the upper portion 416 of the conveyor for allowing the passage of the non-discarded food products towards the front end 106 of the conveyor assembly 102. Although this configuration of the transversal conveyor 124 is preferred, a person skilled in the art will appreciate that numerous transversal belt conveyor configurations may be possible. This person skilled in the art will further appreciate that the presence of the transversal conveyor may not be required and that the workers may opt to discard the rejected food products directly in discard bins conveniently located in the vicinity of the screening station 110.

Since the screening of the food products is performed by individual workers, access to the screening station 110 and extended working periods may require some ergonomics in order to enhance the comfort of the workers and to reduce labour-associated injuries and diseases such as back pain. Such ergonomics may include, for instance, the workers to be at an appropriate height relative to the screening station 110. Accordingly, in one embodiment, the apparatus 100 may be provided with left and right worker steps 128, 130 for allowing the workers to have an ergonomic position relative to the screening station 110.

The food products that have not been discarded (i.e. the quality food products) reach the washing station 112. The washing station 112 comprises a housing 218 mounted on the frame members 202, 204 above the conveyor assembly 102 and a pair of water spraying means 312, 314 housed in the housing 218. The housing 218 has the general configuration of a rectangular box opened at the bottom. More specifically, the housing 218 comprises a back wall 316, a spaced apart front wall 318 and a top wall 320 extending between the back and front walls 316, 318, perpendicular thereto. The housing 218 further comprises a pair of side walls 220 and 222, each side wall 220, 222 connecting the back, front and top walls 316, 318 and 320 at one side of the housing 218. As best shown in FIG. 4, the side walls 220 and 22 enable mounting the housing 218 to the frame members 202, 204. More specifically, each side wall 220, 222 extends slightly below the back and front wall 316, 318 and are positioned above one corresponding frame member 202, 204. Therefore, once properly installed on the frame member 202, 204, a space is provided between the upper portion 416 of the endless track of rollers 404 and the back and front walls 316, 318 of the housing 218 for enabling the passage of the food product under the washing station 112 while traveling from the back end 104 of the conveyor assembly 102 to the front end 106.

An opening 420 is defined at the bottom of the housing 218 for allowing the water spraying means 312 and 314 to spray water onto the food product traveling under the washing station 112, as best described below. The spraying means 312, 314 each comprises a pipe (not shown), the pipes of the two water spraying means 312 and 314 extending parallel to one another between the side walls 220, 222 of the housing 218. The pipes (not shown) are each provided with a plurality of nozzles (not shown) directed toward the upper portion 416 of the endless track of roller 404, for enabling water circulating in the pipes to be sprayed toward the conveyor assembly 102 and on the food product traveling thereon. Each pipe is connected to a clean water source (not shown) by water supply pipe (not show) for feeding the pipes with clean water to be sprayed on the food product with sufficient pressure to remove contaminants such as leaves, soil, herbicide, pesticides and the like from the surface of the food product. According to one embodiment, the cleaning water can be subject to sterilization steps before being feeding the same into the pipes of the washing station. For instance, the water may be subject to filtration, UV sterilization or ozone sterilization prior to be used in the washing stations 112.

The water and contaminants contained therein then pass between the rollers 210 and are collected in the collection pan 304 to further be evacuated through the drain (not shown). A person skilled in the art will appreciate that numerous water spraying means configurations would be possible and that the configuration of the washing station is not limited to the one described above. Further, a person skilled in the art will appreciate that washing products may be added to the clean water sprayed on the food products to improve the washing capabilities of the washing station such as, for instance, an organic fruit and vegetable wash.

As water may impair optimal UV sterilization, it may be desirable to remove water traces from the surface of the food products before subjecting the same to UV treatment, where such a radiation treatment is used. As such, the food products exiting the washing station 112 are conveyed toward the drying station 114. The drying station 114 comprises a pair of parallel air knives 130 and 132 mounted over the conveyor assembly 102 through support members 422. Each air knife 130, 132 comprises an elongated tube 134 extending perpendicular to the conveyor assembly 102, between the frame members 202, 204. The elongated tubes 134 each comprises a first, inlet end coupled to a first end of an air-supply pipe 135, a second, opposed end and a generally straight, elongated slot 424. The elongated slot 424 is facing the upper portion 416 of the roller conveyor 404 and is adapted for providing a high intensity, uniform sheet of laminar airflow toward the conveyor assembly 102. For feeding the air into the air-supply pipe 135 and the air knives 130, 132 coupled thereto, a blower 136 is operatively coupled to a second end of the air-supply pipe 135. As such a blower is susceptible to produce significant noise and make the working environment uncomfortable for the employees; it may be desirable to install the blower 136 at a location remote from the conveyor assembly 102 such as, for instance, in an independent, soundproof room.

The air knives 130, 132 are adapted for efficiently removing a major portion of the water found on the surface of the food products for making the sterilization step more efficient, which sterilization step is carried out in the sterilization station 116. The sterilization station 116 comprises a housing 140 in which are mounted a pair of UV-emitting sources 426 and 428. The housing 140 comprises a pair of space-apart side wall 224, 226, each side wall 224, 226 being mounted upright on a corresponding frame member 202, 204, proximal to the front end 106 of the conveyor assembly 102. The housing 140 also comprises a back wall 330, a front wall 332 and top wall 334. The back, front and top walls 330, 332 and 334 extend between the side walls 224, 226 and are configured to block unwanted emissions of UV light from the light emitting sources 426, 428. At the bottom thereof, the housing 140 is providing with an opening 430 for allowing the UV light to be beamed towards the food products conveyed under the sterilization station 116, as it will become apparent below. While in this embodiment the use of a UV light source is described, a person skilled in the art will appreciate that any other radiation sources capable of providing similar sterilization capabilities to the apparatus 100 could be used. Such other radiation sources comprise, for instance, an X-ray source. Further, while in this embodiment two UV light emitting sources 426, 428 are used, a different number of UV light-emitting sources may be used.

On each side wall 224, 226 are defined two pairs of elevation slots 340a, 340b and 342a, 342b (i.e. four elevation slots on each side wall 224, 226). The elevation slots 340a-340b and 342a-342b are configured for allowing the UV light-emitting sources 426 and 428, respectively, to be moved vertically in the housing 140 for adjusting the distance separating the food products to be sterilized and the UV light-emitting sources 426 and 428. More specifically, each elevation slot (e.g. elevation slot 340a) comprises a generally vertical portion 344 having a bottom end adjacent to a corresponding frame member (e.g. frame member 202) and a top end proximal to the junction between the top and the side wall (e.g. top wall 334 and side wall 224). Each elevation slot (e.g. slot 340a) further comprises a plurality of indentations 346 for receiving therein a carriage member 230 of a corresponding UV light-emitting source 426, 428 to thereby enable vertical adjustment of the light emitting sources 426, 428 relative to the conveyor assembly 102. A person skilled in the art will appreciate that numerous configurations enabling the modification of the distance between the UV-emitting sources 426 and 428 and the conveyor assembly 102 would be possible. For instance, manually or electrically driven screw actuators or pneumatic or hydraulic cylinder could be provided.

The UV light-emitting sources 426, 428 being similar to one another, only UV-light emitting source 428 will be described. A person skilled in the art will appreciate that a similar description also applies to light-emitting source 426. The light-emitting source 428 comprises a generally rectangular frame member 432 in which are mounted a plurality of UV-light tubes (not shown). In one embodiment, the length of the UV-light tubes (not shown) and their position are adapted for the UV light emitted therefrom to span the entire width of the roller conveyor 404 such that food products conveyed thereon will be subject to UV light treatment when in the sterilization station 118, without regard to their position on the roller conveyor 404. For instance, the light-emitting source 428 may comprise three UV light tubes of larger diameter or twelve UV light tubes of smaller diameter, where the larger or smaller diameter light tubes are positioned transverse to the conveyor assembly 102 and span the width of thereof. A person skilled in the art will appreciate that numerous UV light source configurations are possible and that light-emitting source 428 is only described as an example.

In one embodiment, the frame member 432 comprises a back wall, a front wall and a pair of side walls. Extending sidewardly from each side wall are the carriage members 230. Each carriage member 230 comprises a rod made from a rigid material bent to define a U-shape configuration. As such, each carriage member 230 comprises a pair of spaced-apart, sidewardly extending sliding portions 232a, 232b and a handle portion 234 extending therebetween. As best shown in FIG. 1, the sliding portions 232a-232b of each carriage member extend through the elevation slots 342a-342b of the housing 140 and are configured for sliding upwardly and downwardly therein. Thus, the handle portion 234 of the carriage member 230 is located outside the housing 140 for enabling a worker to grip the carriage member 230 and move the light emitting source 428 vertically in the elevation slots 344. Once the proper elevation has been reached, the worker forces the carriage 230 frontwardly (i.e. toward the front wall 332 of the housing 140) for the sliding portions 232a, 232b to engage corresponding indentations 346 of the elevations slots 344 for thereby maintaining the light-emitting source 428 to a desired elevation relative to the conveyor assembly 102.

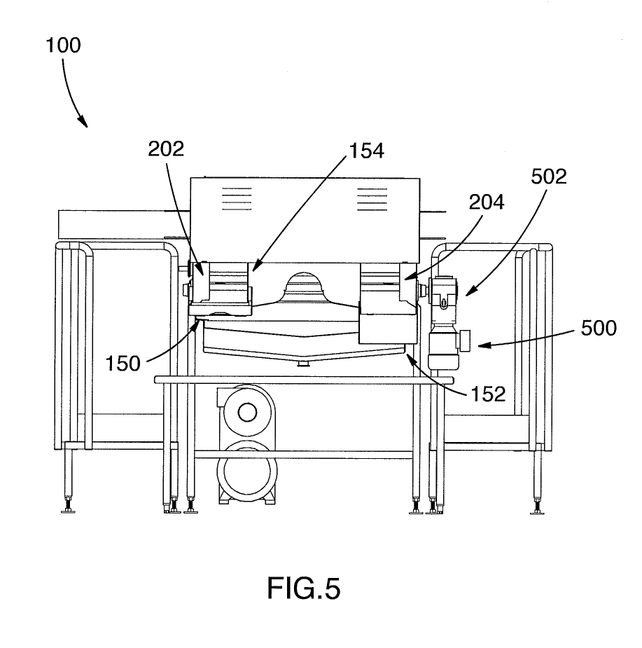

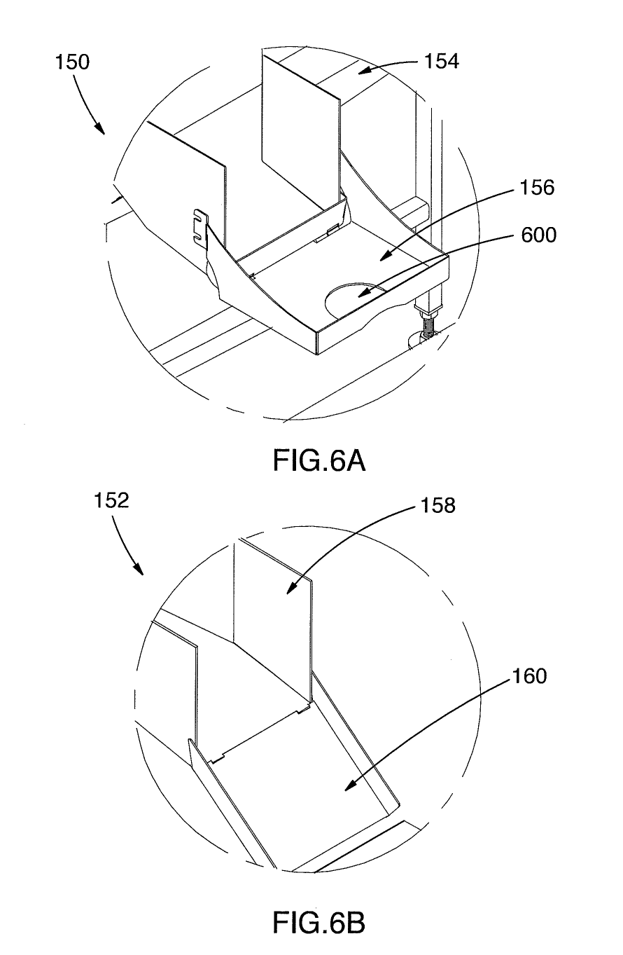

Downstream from the sterilization station 116 is the packaging station 118. According to one embodiment, the packaging station 118 is configured for an operator to collect the food products travelling on conveyor assembly 102 and packaging the same in containers (not shown). According to this embodiment, the packaging station 118 comprises a first, left chute 150 and a second, right chute 152 (best shown in FIGS. 5, 6A and 6B). The first chute 150 comprises a funnel portion 154 extending between the left frame member 202 of the conveyor assembly 102 and the middle of the roller conveyor 404 (i.e. halfway between the frame members 202 and 204) and tapers toward a pivoting plate 156. The pivoting plate 156 is provided with a circular hole 600 for packaging the food product in circular containers. While the food product is funnelled through the funnel portion 154 of the first chute 150, the pivoting plate 156 is lifted upwardly so as to enable the food product to accumulate in the funnel portion 154. Once a proper amount of food product has been accumulated in the funnel portion 154, the pivoting plate is lowered to allow the passage of the food product through the opening 600, toward a container.

In an alternate embodiment, the pivoting plate 150 could be provided with a two holes positioned in a side-by-side relationship for feeding the food products into containers (not shown). In the embodiment, the pivoting plate 150 could further be provided with two pairs of slots for sliding containers therein and maintaining such containers in alignment with the holes during packaging. To further assist a worker in packaging the food product, a pivoting plate in accordance with this embodiment may further be provided with a push plate (not shown) slidably mounted in the pivoting plate 150 and configured for directing the food product toward the holes (not shown).

The second chute 152 also comprises a funnel portion 158, which extends between the middle of the roller conveyor 404 and the right frame member 204. The funnel portion 158 of the second chute 152 tapers toward a drop plate 160 extending downwardly from the funnel portion. The drop plate 160 is configured for packaging the food product of larger diameter (e.g. larger size tomatoes) in standard recipients such as cardboard boxes.

For weighting the amount of food product packaged in the recipient, the apparatus 100 may further include an optional weighting table 170 on which balances (not shown) may be positioned.

Because the apparatus 100 can be used for packaging food products, it is desirable for it to be low maintenance, easy to clean, and rust resistant. Accordingly, in one embodiment, most of the components of the apparatus 100 are manufactured from stainless steel. A person skilled in the art will appreciate that any other suitable material may be used.

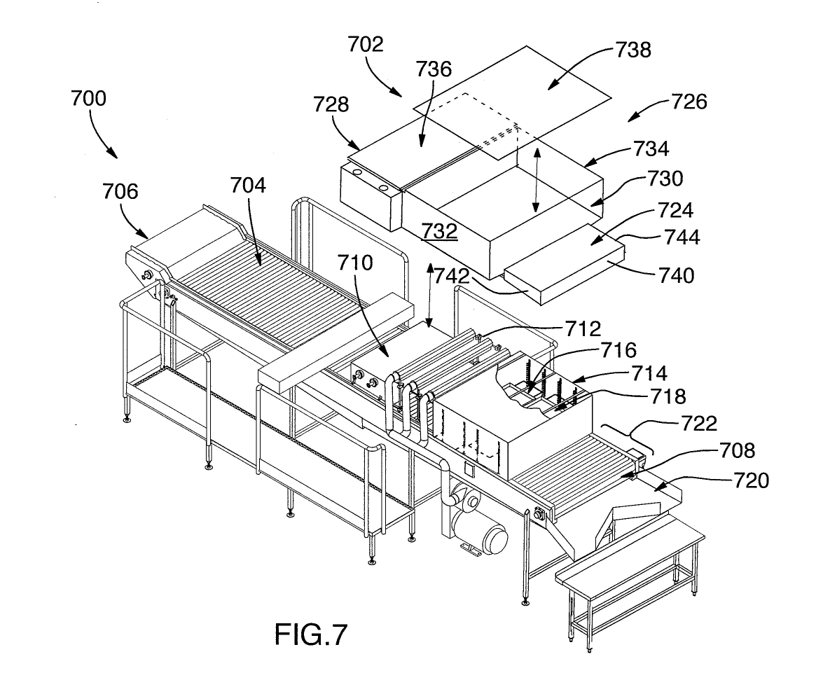

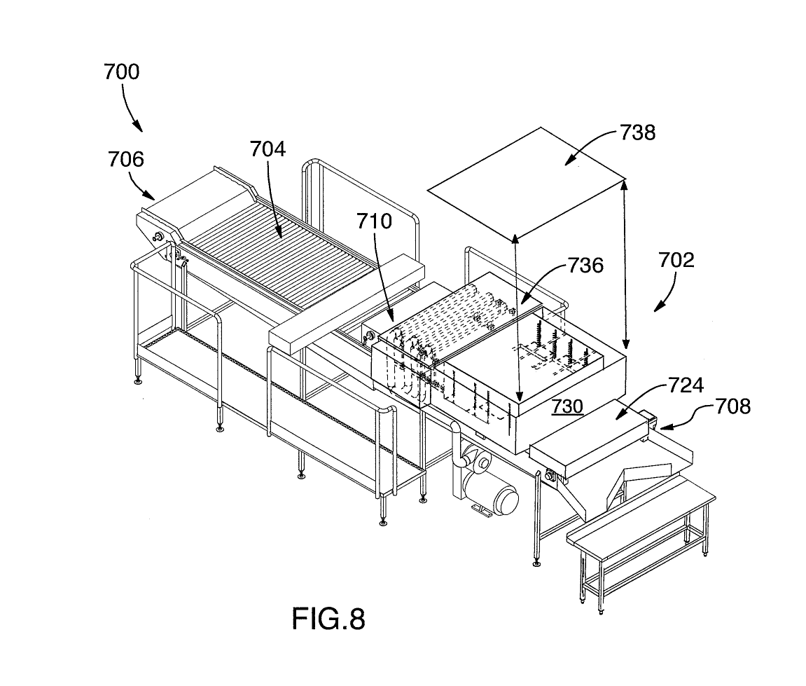

A skilled person will appreciate that the use of UV light or other radiation sources may represent labour hazards, especially for the operators working at the packaging station 118 which are located proximate the sterilization station 116. It may thus be desirable to equipment or means for reducing the emission of UV light or other types of radiations toward the workers, or, in other words, confining the radiation beams. Therefore, in accordance with one embodiment illustrated in FIGS. 7 and 8, there is provided an apparatus 700 comprising a UV shield 702 for preventing unwanted emission of UV light towards workers. In this embodiment, the apparatus 700 comprises a conveyor assembly 704 having a back end 706 and a front end 708. The apparatus also comprises a washing station 710, a drying station 712 and a sterilization station 714 mounted to the conveyor assembly 704, the sterilization station 714 being provided with UV light sources 716, 718. At the front end 708 thereof, the conveyor assembly 704 is provided with a packaging station 720.

As best shown in FIG. 7, the sterilization station 714 of the apparatus 700 is located slightly reward of the front end 708 of the conveyor assembly 704 to provide a space 722 between sterilization station 714 and the packaging station 720. The space 722 is adapted for receiving a front portion 724 of the UV shield 702, as it will become apparent below.

The UV shield 702 is mounted to the conveyor assembly 704 and comprises a main back portion 726 and the front portion 724. The back portion 726 has the shape of a generally rectangular box and covers the drying station 712 and the sterilization station 714, as best shown in FIG. 8. It comprises a back wall 728 adjacent to the washing station 710, a front wall 730, a pair of side walls 732, 734 and a top wall 736. According to one embodiment, a portion of the top wall 736 is provided with a removable portion 738 that can be removed, for instance, to adjust the distance between the UV light sources 716, 718 and the conveyor assembly 704.

The front portion 724 of the UV shield 702 is designed to cover the space 722 between the sterilization station 714 and the packaging station 720. Accordingly, the front portion 724 of the shield 702 comprises a back wall (not shown) adjacent to the front wall 730 of the back portion 726, a front wall 740, a pair of side wall 742, 744 and a top wall 746. The front wall 740 extends slightly below the side walls 742, 744, toward the packaging station 720, to further prevent UV light from being directed toward the workers.

According to one embodiment, the UV shield is made from stainless steel. A person skilled in the art will appreciate that stainless steel being reflective, it may be desirable to minimize reflection of UV light to further reduce unwanted emission toward the workers. Accordingly, in one embodiment, the interior of the UV shield is treated for reducing reflection. Treatment for reducing reflection may include, for instance, sandblasting or brushing the interior of the UV shield 702 to provide mat surfaces.

According to another embodiment, the packaging station 720 is also made from stainless steel. To further reduce reflection of UV light, the packaging station 720 may also be treated for providing mat surfaces such as by sandblasting or brushing.

Having described the general components of the apparatuses 100 and 700, its operation will now be described in accordance with one embodiment of the present invention, referring to apparatus 100. A person skilled in the art will appreciate that the operation of the apparatus 700 is similar.

In accordance with this embodiment, the worker discharged the unclean, unprocessed food product on the discharge station 108. The food product may come directly from a producer, from a wholesale distributor or from any other source. Once on the discharge station 108, the food product is directed toward the upper portion 416 of the roller conveyor 404 of the conveyor assembly 102, at the back end 104 thereof.

The drive assembly 216 is actuated to drive movement of the conveyor assembly 102. More specifically, the upper portion 416 of the roller conveyor 404 is urged to move from the back end 104 toward the front end 106 so as to convey the food products from the discharge station 108 to the packaging station 118. As the upper portion 416 of the roller conveyor 404 moves frontwardly, the rollers 210 contact the pair of upper slides 402 all along their length. The frictional engagement between the rollers 210 and the pair of upper slides 402 causes the rollers to rotate counterclockwise (when seen on FIGS. 3 and 4). This rotation of the rollers 210 while they are traveling from the back end 104 to the front end 106 causes the food products conveyed on the conveyor to change of orientation, thereby randomly exposing their different surfaces while traveling through the screening station 110, the washing station 112, the drying station 114 and the sterilization station 116.

In while the food products are conveyed through the screening station 110, the workers separate the quality food products and the rejected food products remove (i.e. food products not meeting the quality standards for packaging). The rejects are placed on the transversal belt conveyor 124 to convey the rejects toward the discharged bin. The food products that meet the quality standards for packaging are left on the conveyor assembly 102, which direct them toward the washing station 112. While passing through the washing station 112, the quality food products are subjected to sprays of water from the water spray means 314, 316. The sprays of water are adapted for removing the soil and other contaminants that may be found on the surfaces of the food products, the different surfaces of the food products being exposed sequentially and randomly exposed by the rotation of the rollers 210. Water and debris are collected in the pan 304 and evacuated through the drain (not shown).

The washed food products are then conveyed to the drying station 114. At this location, the water found on the surface of the food products is removed by the air knives 130, 132. Again, the rotation of the rollers 210 will ensure that all the surfaces of the food product are exposed to the laminar flow of air and that the food products are exempt from most of the water used for washing.

The dry food products are then conveyed downstream the drying station 114, in the sterilization station 116. As the food products are conveyed through the sterilization station 116, the UV light produced by the UV light-emitting sources kills or destroys bacteria, funguses such as molds and other micro-organisms that may be found on the surface of the food product to obtain ready-to-eat food products.

At the exit of the sterilization station 116, the ready-to-eat food products are ready for packaging. The food products are conveyed into at least one of the chutes 150 and 152, under which packaging containers are placed. The food product is then put in the package containers and made ready for shipment to grocery stores, wholesale distributors and the like.

According to one embodiment, the operation parameters of the apparatus 100 can be adjusted on the basis of the nature of the food product process and the amount of contaminants found thereon. For instance, a food product having a porous or rough surface (e.g. a kiwi or a citrus) may require more washing and sterilization time than a food product having a very smooth surface and delicate surface (e.g. a tomato). Similarly, where the surface of the food product is covered by a substantial amount of soil, leaves and the like, the washing and drying steps may require more time than the same product relatively exempt from such contaminants. Thus speed of conveyor assembly 102, flow of water through the washing station 112, the flow of air exiting the air knives 130 and 132 to dry up the food product and, the intensity of the UV light-emitting sources 426 and 428 and the distance separating the UV light-emitting sources 426 and 428 lamp assemblies from the upper portion 416 surface of the roller conveyor 404 could be controlled. These parameters can be controlled independently and manually by a worker or, alternately, be controlled by a computer comprising parameters preset in the computer based on the nature of the food product and the amount of contaminants for thereon.

Although the foregoing description and accompanying drawings relate to specific preferred embodiments of the present invention as presently contemplated by the inventor, it will be understood that various changes, modifications and adaptations, may be made.

1. An apparatus for sterilizing a product using radiation, the apparatus comprising:
a conveyor assembly having a back end and a front end, the conveyor assembly being adapted for conveying said product between said back end and said front end;
a radiation source mounted on said conveyor in an intermediate location between said back end and said front end, the radiation source being adapted for allowing the passage of the food product from said back end of said conveyor assembly and said front end and directing a radiation beam toward said product; and
means for causing rotation of said product as it is conveyed between said back end and said front end of said conveyor assembly, said rotation enabling said food product to be uniformly reached by said radiation beam.

2. The apparatus of claim 1, wherein said radiation comprises an Ultraviolet (UV) light and said radiation source comprises a UV light-emitting source.

3. The apparatus of claim 1, further comprising a screening station for screening said product before subjecting the same to said radiation beam, said screening station being located between said back end of said conveyor assembly and said radiation source.

4. The apparatus of claim 3, further comprising a transversal conveyor for facilitating discard of a reject product, said transversal conveyor being mounted to said conveyor assembly between said back end of said conveyor assembly and said radiation source.

5. The apparatus of claim 1, further comprising a washing station for washing the product before subjecting the same to said radiation beam, said washing station being mounted to said conveyor assembly between said back end and said radiation source.

6. The apparatus of claim 5, further comprising a drying station for drying said product before subjecting the same to said radiation beam, said drying station being mounted to said conveyor assembly between said washing station and said radiation source.

7. The apparatus of claim 1, further comprising a discharge station mounted at said back end of said conveyor assembly for feeding said product on said conveyor assembly.

8. The apparatus of claim 1, further comprising a packaging station mounted at said front end of said conveyor assembly.

9. The apparatus of claim 8, wherein said packaging station comprises at least one chute.

10. The apparatus of claim 1, further comprising a shield mounted over said radiation source for limiting unwanted reflection of said radiation beam.

11. The apparatus of claim 1, wherein said means for causing rotation is operatively coupled to said conveyor assembly.

12. The apparatus of claim 11, wherein said means for causing rotation is a roller conveyor.

13. The apparatus of claim 1, wherein said product comprises a food product.

14. The apparatus of claim 13, wherein said food product comprises a perishable food product.

15. The apparatus of claim 14, wherein said perishable food product is selected from the group consisting of a fruit and a vegetable.

16. The apparatus of claim 15, wherein said fruit comprises a tomato.

17. An apparatus for sterilizing a food product using Ultraviolet (UV) light, the apparatus comprising:
a roller conveyor assembly having a back end and a front end, the roller conveyor assembly being adapted for conveying said product between said back end and said front end;
a UV light-emitting source mounted on said conveyor in an intermediate location between said back end and said front end, the UV light-emitting source being adapted for allowing the passage of the food product from the back end of said conveyor assembly and said front end and directing a UV light beam toward said product;
a screening station for screening said food product before subjecting the same to said UV light beam, said screening station being located between said back end of said conveyor assembly and said UV light source;
a washing station for washing the product before subjecting the same to said radiation beam, said washing station being mounted to said conveyor assembly between said screening station and said UV light source; and
a drying station for drying said product before subjecting the same to said UV light beam, said drying station being mounted to said conveyor assembly between said washing station and said UV light source.
wherein said roller conveyor assembly causes said food product to rotate while being conveyed between said back ends and said front end of said roller conveyor assembly, said rotation enabling said food product to be uniformly reached by said UV light beam.

18. The apparatus of claim 17, further comprising a transversal conveyor for facilitating discard of a reject product, said transversal conveyor being mounted to said conveyor assembly between said back end of said conveyor assembly and said radiation source.

19. The apparatus of claim 17, further comprising a packaging station mounted at said front end of said conveyor assembly.

20. The apparatus of claim 17, wherein said packaging station comprises at least one chute.

21. The apparatus of claim 17, further comprising a shield mounted over said UV light source for confining said UV light beam.

22. A method for sterilizing a food product using Ultra Violet (UV) light, the method comprising:
providing a UV light source for emitting a UV light beam;
exposing said food product to said UV light beam while rotating said food product for enabling the same to be uniformly reached by said UV light beam.

23. The method of claim 22, further comprising screening said food product prior to exposing said food product to said UV light beam.

24. The method of claim 22, further comprising washing said food product prior to exposing said food product to said UV light beam.

25. The method of claim 24, further comprising drying said food product after washing and prior to exposing said food product to said UV light beam.

26. A method for packaging ready-to-eat food products, the method comprising:
providing unprocessed food products;
screening said unprocessed food products to separate quality food products and rejected food products;
washing said quality food products to obtained washed food products;
drying said washed food products to obtain dry food products;
submitting said dry food products to a Ultraviolet (UV) light beam while rotating the same such that said food products are uniformly reached by said UV light beam to obtain said ready-to-eat food products;
packaging said ready-to-eat food products in a container.
